(19) United States
(12) Patent Application Publication
(10) Pub. No.: US 2006/0139248 A1
(43) Pub. Date: Jun. 29, 2006

(54) Planar display apparatus

(75) Inventors: Toshimitsu Watanabe, Yokohama (JP); Nobuaki Kabuto, Kunitachi (JP); Mutsumi Suzuki, Kodaira (JP); Masakazu Sagawa, Inagi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/292,438

(22) Filed: Dec. 2, 2005

(30) Foreign Application Priority Data
Dec. 3, 2004 (JP) 2004-350545

(51) Int. Cl. G09G 3/22

(52) U.S. Cl. 345/75.2

(57) ABSTRACT

A technique capable of displaying an efficient bright image in an image display apparatus using electron sources is provided. The image display apparatus includes a plurality of electron sources, and a plurality of phosphors provided so as to be opposed to the electron sources, light being emitted by the phosphors in response to electrons emitted from the electron sources. The electron sources are capacitive electron sources formed by sandwiching an insulation layer between two metal layers. And two capacitive electron sources electrically connected in series are disposed so as to be associated with each of the phosphors.

### INCORPORATION BY REFERENCE

The present application claims priority from Japanese application JP 2004-350545 filed on Dec. 3, 2004, the content of which is hereby incorporated by reference into this application.

### BACKGROUND OF THE INVENTION

1. Field of the Invention

The present invention relates to an image display apparatus, such as field emission display (hereafter abbreviated to “FED”), which forms an image by causing electrons from an electron source to strike against a phosphor and emitting light.

2. Description of the Related Art

As conventional techniques for causing one phosphor to emit light using electrons from two electron sources in the FED, techniques described in JP-A-5-2984, JP-A-10-55748 and JP-A-2001-273859 are known.

### SUMMARY OF THE INVENTION

In JP-A-5-2984 and JP-A-10-55748, a configuration using the electron sources of surface conduction type is disclosed. In JP-A-5-2984 and JP-A-10-55748, however, a configuration using electron sources of the so-called MIM (Metal Insulator Metal, hereafter abbreviated to simply as “MIM”) type obtained by sandwiching an insulation layer between two metal layers as electron sources is not considered.

In JP-A-2001-273859, it is disclosed to cause one phosphor to emit light using two MIM elements. In JP-A-2001-273859, however, two MIM type electron sources are connected in parallel. Since the MIM has a structure obtained by sandwiching an insulation layer between two metal layers as described above, the MIM has capacitive impedance. If two MIM type electron sources having the same capacitance are connected in parallel, therefore, capacitance per pixel (a set of the phosphor and an electron source) is doubled and the time constant is also doubled. Even if the two MIM type electron sources connected in parallel are driven (with the same drive voltage) simultaneously to, for example, double the light emission from the phosphor, therefore, the light emission time (drive time of the MIM) is not doubled because of the increase in the time constant. Even if it is attempted to increase the brightness in the configuration described in JP-A-2001-273859, therefore, a high efficiency cannot be obtained.

The present invention provides a technique capable of displaying a bright image efficiently.

In accordance with the present invention, in an image display apparatus using capacitive electron sources formed by sandwiching an insulation layer between two metal layers as electron sources, each phosphor is caused to emit light by using at least two electron sources electrically connected in series.

Supposing that each MIM has capacitance Cm, composite capacitance obtained by connecting two MIMs in series is halved to Cm/2. Accordingly, the time constant in each pixel is also halved as compared with the case where only one MIM is used. Thus, the time (rise time) between supply of a drive voltage pulse to the MIMs and arrival at the peak can be shortened. As compared with the case where only one MIM is used for each phosphor and the case where two MIMs are used for each phosphor and the two MIMs are connected in parallel, therefore, the light emission time (MIM drive time) can be lengthened. According to the present invention, therefore, the displayed image can be made bright with high efficiency.

When it is desired to obtain brightness that is approximately twice the brightness obtained when one MIM is used, it is desirable to apply the same drive to the two MIMs connected in series. In the case where favorable white balance is not obtained when displaying the white color, such as in the case where a white color in which the light emission luminance of green is weak and the magenta color is strong is displayed, drives for two MIMs associated with each of red and blue phosphors may be made different from each other. As to two electron sources associated with each of the red and blue phosphors at this time, voltage-electron emission characteristics of one of the two electron sources may be made lower than voltage-electron emission characteristics of the other of the two electron sources.

In this way, according to the present invention, the displayed image can be made bright with high efficiency.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a first embodiment according to the present invention;

FIG. 2 is a detailed diagram showing a concrete configuration in the embodiment shown in FIG. 1; and

FIG. 3 is a diagram showing voltage versus electron emission characteristics of the MIM showing a second embodiment according to the present invention.

### DESCRIPTION OF THE INVENTION

Hereafter, embodiments according to the present invention will be described with reference to the drawings.

### FIRST EMBODIMENT

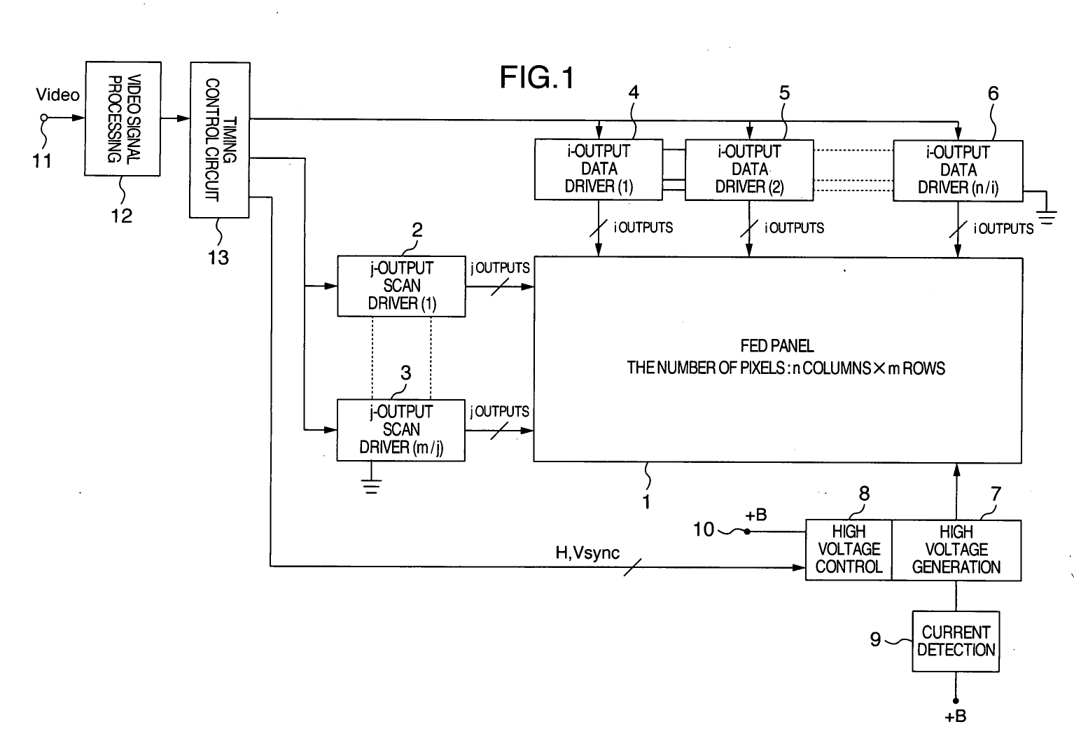

FIG. 1 is a diagram showing an embodiment of an image display apparatus according to the present invention.

A FED panel 1 is a video display apparatus using a passive matrix scheme. As described later, the FED panel 1 includes a plurality of data lines, a plurality of scanning electrode lines, and a plurality of electron sources connected to points of intersection of the data lines and the scanning electrode lines. The electron sources used in the present embodiment are the so-called MIM type electron sources obtained by sandwiching an insulation layer between two metal layers. Hereafter, electron sources are referred to as MIM in the same way as the foregoing description. Scan drivers 2 and 3 are connected to scanning electrode lines. Data drivers 4 to 6 are connected to data lines. It is now supposed that the number of horizontal pixels is n and the number of vertical pixels is m in the FED panel 1. If an LSI having i outputs is used as each of the data drivers, n/i data drivers are needed. If an LSI having j outputs is used as each of the scan drivers, m/j scan drivers are needed. In the present embodiment, it is supposed that three data drivers and two scan drivers are used for simplifying the description. As a matter of fact, more drivers are used. A high voltage generation circuit 7 and a high voltage control circuit 8 are connected to an anode terminal of the FED panel 1. Power from a power supply terminal 10 is supplied to the high voltage control circuit 8. The scan drivers 2 to 3, the data drivers 4 to 6, and the high voltage control circuit 8 are controlled by signals from a timing control circuit 13. Hereafter, operations of various components will be described.

A video signal input from a video signal terminal 11 is subjected to various adjustments as to the amplitude, black level and hue in a video signal processing circuit 12, and input to the timing control circuit 13. On the basis of a video signal adjusted in the video signal processing circuit 12, and horizontal and vertical synchronization signals input together with the video signal, the timing control circuit 13 transmits an optimum timing signal for displaying a video image on a display screen of the FED panel 1 and video data to the scan drivers 2 to 3, the data drivers 4 to 6, and the high voltage control circuit 8. The data drivers 4 to 6 retain video data corresponding to one line on the FED panel 1 over one horizontal interval, and rewrite data every horizontal period in synchronism with a horizontal synchronization timing signal supplied from the timing control circuit 13. And the retained video data corresponding to one line is converted to an analog signal by D-A converters incorporated in the data drivers 4 to 6, and supplied from the data drivers 4 to 6 to the data lines as drive signals for driving the electron sources. On the other hand, the scan drivers 2 to 3 successively select scanning electrode lines of the FED panel 1 in the vertical direction by one row (or several rows). The scanning line electrode selection is conducted by applying a selection voltage of, for example, 5 V (or −5 V) to a certain scanning line electrode. When a scanning line electrode is not selected, a voltage of, for example, 0 V is applied to the scanning line electrode. Vertical scanning is conducted by applying the selection voltage to scanning line electrodes successively from the top by one row (or several rows) in response to a timing signal of horizontal synchronization supplied from the timing control circuit 13.

If a selection voltage is applied to a certain scanning electrode line, electrons according to a potential difference between the selection voltage and drive signals from the data drivers 4 to 6 are emitted from the MIM of one line connected to the scanning line electrode. Here, the drive signal and the selection voltage are opposite in polarity to each other. For example, if the selection voltage is positive, the drive signal becomes negative. A high voltage (anode voltage) of several kV from the high voltage generation circuit 7 is applied to the anode terminal of the FED panel 1. Electrons from the MIM are accelerated by this anode voltage to strike against phosphor provided in the FED panel 1 so as to correspond to the electron sources and excite the phosphor. As a result, the phosphor correspond to one row emits light, and a video image corresponding to one horizontal line is displayed on a display surface of the FED panel 1. If all of the scanning line electrodes are successively selected by the scan drivers 2 to 3 in one frame interval, a video image of one frame is displayed on the display surface. If a video image displayed on the FED panel 1 is bright, the load current from the high voltage generation circuit 7 is large. If the video image is dark, the load current becomes small. The voltage value of the high voltage generation circuit 7 becomes lower as the load current increases. By detecting this load current using the current detection circuit 9 and exercising feedback control using the high voltage control circuit 8, the voltage value is kept constant. In this way, control of high voltage stabilization is exercised.

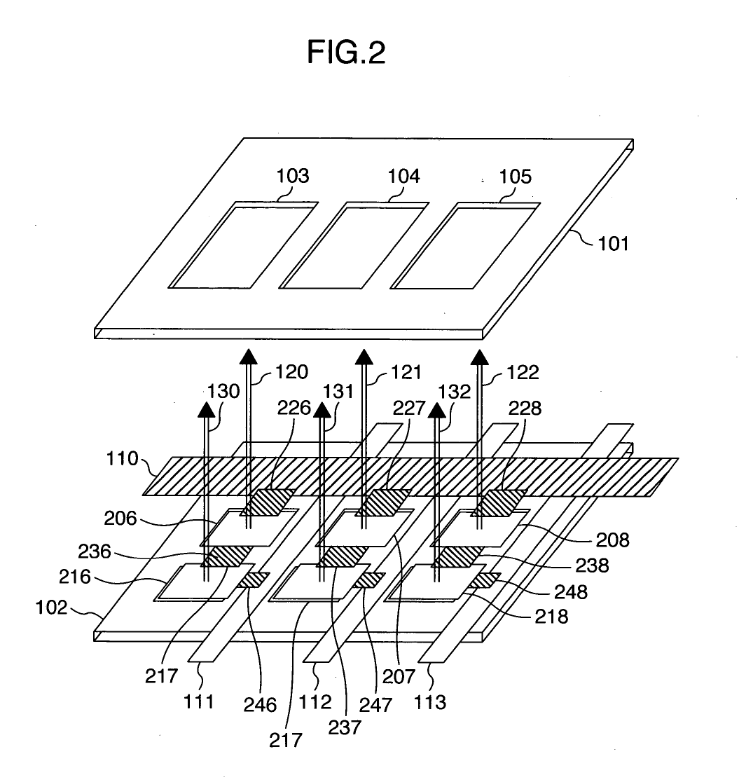

An internal configuration of the FED panel 1 will now be described with reference to FIG. 2. FIG. 2 schematically shows a structure of three pixels, red, blue and green. The FED panel 1 includes an anode board 101 serving as a first substrate such as glass having a light transmitting property, and a cathode board 102 serving as a second substrate. On the anode board 101, red phosphor 103, green phosphor 104, and blue phosphor 105 are formed. On the cathode board 102, red MIMs 206 and 216 are provided so as to be associated with the red phosphor 103, green MIMs 207 and 217 are provided so as to be associated with the green phosphor 104 and blue MIMs 208 and 218 are provided so as to be associated with the blue phosphor 105. In other words, in the present embodiment, two MIMs are provided so as to be associated with each of the red, blue and green phosphors. Although two MIMs are provided so as to be associated with each phosphor, two or more MIMs, for example, three MIMs may also be provided.

Upper electrodes of the MIMs 206, 207 and 208 are connected to a common scanning electrode line 110 via connection wiring patterns 226, 227 and 228, respectively. Lower electrodes of the electron sources 206, 207 and 208 are connected to upper electrodes of the electron sources 216, 217 and 218 via connection wiring patterns 236, 237 and 238, respectively. Lower electrodes of the electron sources 216, 217 and 218 are connected to independent data lines 111, 112 and 113, respectively. As a result, the red MIMs 206 and 216 are electrically connected in series. The green MIMs 207 and 217 are electrically connected in series. The blue MIMs 208 and 218 are electrically connected in series. The MIMs 206, 207, 208, 216, 217, and 218 respectively emit electron beams 120, 121, 122, 130, 131 and 132 each having strength depending upon selection time (i.e., selection voltage applying time) of the common scanning electrode line 110 and the voltage value of the drive signal applied to the data line.

The electron beams are accelerated toward the phosphors 103 to 105 by the anode voltage applied to the anode board 101 to strike against the phosphors 103 to 105, respectively. The phosphors 103 to 105 are excited by the striking of the electron beams to cause pixels having predetermined colors to be luminous. The phosphor 103 has a size that is approximately equal to the sum of sizes of the MIMs 206 and 216. The phosphor 103 is excited by the electron beams 120 and 130 to emit light. The same holds true of the relation in size between the MIMs 207 and 217 and the phosphor 104, and the relation in size between the MIMs 208 and 218 and the phosphor 105. Thus, in the present embodiment, at least two MIMs for causing one phosphor to emit light are connected in series. The two MIMs associated with each phosphor have the same voltage-electron emission characteristics, and conduct the same driving. As compared with a configuration using one MIM for one phosphor, therefore, the luminance can be increased remarkably. Supposing that the voltage applied between the scanning electrode line 110 and the data line 111 is 2Vm, the voltage between the upper electrode and the lower electrode of the MIM 216 and the voltage between the upper electrode and the lower electrode of the MIM 206 are Vm. In other words, in the present embodiment, the voltage between the upper electrode and the lower electrode is doubled as compared with the configuration using one MIM for one phosphor.

The case where two MIMs are connected in parallel with respect to one phosphor will be compared with the case where two MIMs are connected in series as in the present embodiment. In the ensuing description, the voltage for driving a MIM, pixel capacitance of the MIM, and an electron emission area of the MIM are denoted by Vm, Cm and Sm, respectively. First, the case where two MIMs connected in parallel are used with respect to one phosphor in order to double the electron emission area Sm and double the light emission luminance will now be considered. In this case, the area of the MIMs becomes 2Sm, and the capacitance of the MIMs per pixel becomes 2Cm. Supposing that drive energy Em at the time when one MIM is used per phosphor (at the time of reference driving) is represented as (Cm·Vmˆ2)/2, drive energy Ep at the time of the parallel connection is represented by the following equation (1).
Ep=(2·Cm·Vmˆ2)/2=2Em (1)

In this way, the drive energy at the time of the parallel connection becomes twice that at the time of reference driving. On the other hand, luminance of light emission from the phosphor is substantially equal to a product of an electron beam emission quantity per time and light emission time of phosphor (MIM drive time). The electron beam emission quantity per time is proportionate to the drive voltage Vm. Denoting its proportionality by k, the electron beam emission quantity per time is represented as k·2Vm. On the other hand, light emission time of phosphor is represented by (Tm−Tc), where Tm is the selection interval of the scanning electrode line 110 and Tc is MIM charge storage time. This charge storage time Tc, i.e., a time delay for charging the capacitance Cm depends on a time constant determined by a product of Rm and Cm, where Rm is wiring resistance of the scanning electrode line 110. If the MIMs are connected in parallel as described above, capacitance per pixel is doubled. Therefore, luminance Lp of light emission from the phosphor at the time of the parallel connection is represented by the following equation
Lp=k·2Vm(Tm−Tc)=k·2Vm(Tm−2Rm·Cm) (2)

In this way, when two MIMs are connected in parallel, capacitance per pixel is increased to twice. Therefore, time (rise time) between application of a drive voltage pulse to the MIMs and arrival at the peak is also doubled as compared with the case where one MIM is used. At the time of the parallel connection, therefore, light emission time of the phosphor becomes short, and it becomes difficult to improve the luminance efficiently even if two MIMs are used. (In other words, even if two MIMs are used, the luminance cannot be simply doubled.)

On the other hand, the case where two MIMs connected in series are used for one phosphor in order to double the electron emission area Sm and thereby double the light emission luminance as in the present embodiment will now be considered. Taking MIMs for red as an example and supposing that each of the MIMs 216 and 206 has capacitance Cm, capacitance per pixel (i.e., capacitance between the scanning electrode line 110 and the data line 111) becomes Cm/2. Furthermore, the drive voltage is doubled (i.e., the voltage of 2Vm is applied between the MIM 206 and the MIM 216). Therefore, drive energy Es and luminance Ls of light emission from the phosphor at the time of the series connection are represented by equations (3) and (4), respectively.
Es=(Cm/2(2·Vm)ˆ2)/2=2Em (3)
Ls=k·2Vm(Tm−Rm−Cm/2) (4)

When doubling the MIM area in order to ensure the doubled electron beam quantity, the case where two MIMs are connected in parallel is compared with the case where two MIMs are connected in series. In both cases, the drive energy is Cm·Vmˆ2 and the same. As represented by the equation (2), however, the light emission luminance Ep at the time of the parallel connection becomes equal to k·2·Vm(Tm−2Rm·Cm). On the other hand, as represented by the equation (4), the light emission luminance Es at the time of the series connection becomes equal to k·2·Vm(Tm−Rm·Cm/2). In other words, at the time of the series connection, the MIM charge storage time Tc becomes equal to ¼ times that at the time of the parallel connection. As compared with the time of the parallel connection, therefore, light emission time (Tm−Tc) of the phosphor can be made remarkably long. In other words, even if the drive energy and the area (electron emission area) of the MIMs are equal, higher luminance can be obtained in the case where the MIMs are connected in series and driven. In the present embodiment, the drive voltage is doubled (2Vm). Since the drive energy Es at the time of serial driving is equal to the drive energy Ep at the time of parallel connection, however, the light emission luminance obtained using unit drive energy is greater in the present embodiment.

In this way, according to the present embodiment, the light emission luminance per unit drive energy can be increased, and the luminance of the displayed image can be improved with high efficiency.

When obtaining the same luminance, the current flowing through the scanning line can be reduced. It is also possible to obtain a picture quality improvement effect that picture quality degradation caused by a voltage drop across scanning line resistance is suppressed. Furthermore, even if one of two MIMs is formed not as an electron source but as a resistor because of a process fault or the like, light emission from the phosphor can be conducted and the panel yield can be improved, resulting in an effect.

### SECOND EMBODIMENT

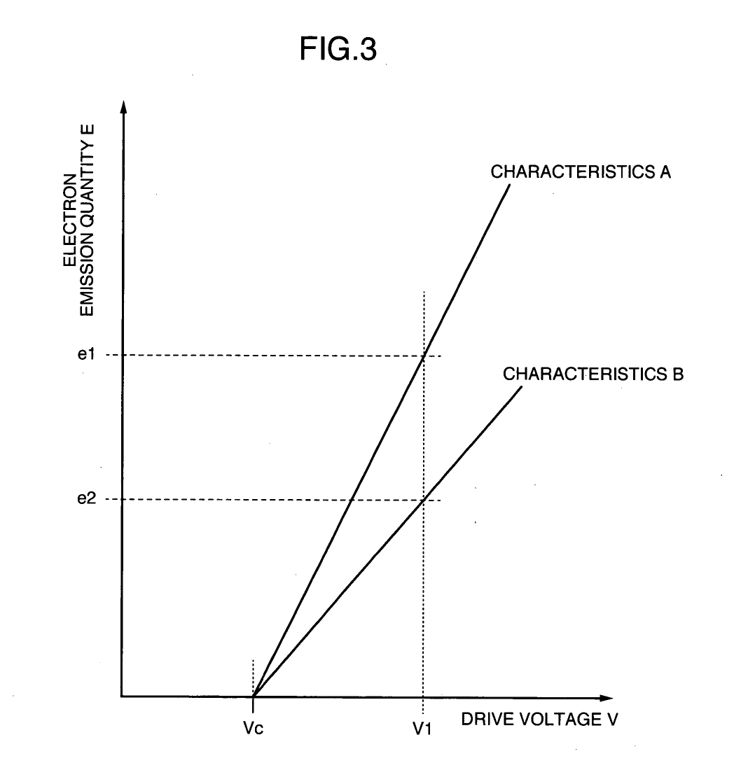

A second embodiment of the present invention will now be described with reference to FIG. 3. In the first embodiment, the MIMs connected in series are subject to the same drive. Alternatively, the MIMs connected in series may be subject to different drives. Such drives are effective to the case where red, blue and green are relatively different in light emission luminance.

As the phosphors 103, 104 and 105 shown in FIG. 2, the same materials as those of phosphors used in projection cathode-ray tubes are used. For example, Y₂O₃:Eu is used as the red phosphor 103, Y₂SiO₅:Tb is used as the green phosphor 104, and ZnS:Ag, Cl is used as the blue phosphor 105. In this case, the red and blue phosphors become relatively strong in light emission intensity (in other words, the green phosphor is relatively weaker in light emission intensity than the red and blue phosphors.) Even if drive voltage levels of the MIMs 206, 216, 207, 217, 208 and 218 are made equal and intensities of electron beams generated from the MIMs are made substantially equal in order to display a white video image on a display surface of the FED panel 1, therefore, the displayed video image becomes a white color having a strong magenta color. In other words, in the FED using phosphors as described above, light emission luminance characteristics of the phosphors are different from each other, and consequently a white color of a high color temperature is not obtained and favorable white balance is not obtained.

In the present embodiment, therefore, drives of the two MIMs 207 and 217 associated with the green phosphor 104 are made the same, and drives of the two MIMs 206 and 216 associated with the red phosphor 103 are made different from each other. Drives of the two MIMs 208 and 218 associated with the green phosphor 105 are made different from each other. Specifically, the red MIMs 206 and 216 are made different from each other and the blue MIMs 208 and 218 are different from each other, in voltage-electron emission characteristics. For example, as shown in FIG. 3, the MIM 206 and the MIM 208 are provided with first characteristics A as the voltage-electron emission characteristics, and the MIM 216 and the MIM 218 are provided with second characteristics B as the voltage-electron emission characteristics. The axis of abscissas in FIG. 3 indicates a level V of a drive voltage applied to the MIM. The axis of ordinates indicates an electron emission quantity E emitted from the MIM. In addition, Vc indicates a threshold voltage at which the MIM starts the electron emission. It is supposed that the first characteristics A and the second characteristics have the same threshold voltage Vc. In the present embodiment, the first characteristics A become higher than the second characteristics B.

The case where MIMs having such characteristics are connected in series as in the first present embodiment will now be described by taking MIMs associated with the red phosphor 103 as an example. If the drive voltage V1 is applied to the two MIMs 206 and 216 associated with the red phosphor 103, the MIM 206 emits an electron quantity E1 as indicated by the first characteristics A and the MIM 216 emits an electron quantity E2 as indicated by the second characteristics B. The same is true of the MIMs associated with the blue phosphor 105. It is supposed that the two MIMs 207 and 217 associated with the green phosphor 104 have the first characteristics A. If at this time the drive voltage V1 of the same level is applied to the MIMs associated with the red, blue and green phosphors 103 to 105, the electron emission quantity from the two MIMs associated with each of the red and blue phosphors 103 and 105 becomes less than the electron emission quantity from the two MIMs associated with the green phosphor 104. Even if the drive voltage of the same level is applied to the MIMs, therefore, the light emission luminance of the red and blue phosphors 103 and 105 becomes less than the light emission luminance of the green phosphor 104. In other word according to the configuration of the present embodiment, the relative luminance of the green phosphor can be made higher than the relative luminance of the red and blue phosphors. It is improved in that a white color having a strong magenta color is displayed at the time of white color display.

For providing the MIM 216 and MIM 218 with the second characteristics B, the area of each of the MIMs (the area of each of the insulation layers) should be made smaller than that of each of the MIM 206 and the MIM 208, and the thickness between metal layers in the MIM 216 and the MIM 218 should be made greater than that in the MIM 206 and the MIM 208. By doing so, the capacitance and the threshold voltage Vc of the MIM 216 and the MIM 218 are made substantially equal to those of the MIM 206 and the MIM 208, and the voltage-electron emission characteristics of the MIM 216 and the MIM 218 can be made lower than those of the MIM 206 and the MIM 208. If a drive voltage is applied across, for example, the MIMs 206 and 216 connected in series, therefore, the MIMs are equal to each other in capacitance and consequently the drive voltage applied to each MIM by voltage division can be made equal to each other. Even if the voltage-electron emission characteristics of the two MIMs connected in series are made different from each other, control of the electron emission quantity is facilitated.

In this way, it becomes possible according to the present embodiment to obtain favorable white balance while obtaining the effects of the first embodiment.

It should be further understood by those skilled in the art that although the foregoing description has been made on embodiments of the invention, the invention is not limited thereto and various changes and modifications may be made without departing from the spirit of the invention and the scope of the appended claims.

1. An image display apparatus comprising:
a plurality of electron sources arranged in a matrix form; and
a plurality of phosphors provided so as to be opposed to the electron sources, light being emitted by the phosphors in response to electrons emitted from the electron sources,
wherein
the electron sources are capacitive electron sources formed by sandwiching an insulation layer between two metal layers, and
at least two capacitive electron sources electrically connected in series are disposed so as to be associated with each of the phosphors.

2. An image display apparatus comprising:
a first substrate having red, blue and green phosphors provided thereon; and
a second substrate having at least two electron sources provided so as to be associated with each of the red, blue and green phosphors,
wherein
the electron sources are MIM type electron sources formed by sandwiching an insulation layer between two metal layers, and
the two MIM type electron sources are electrically connected in series.

3. The image display apparatus according to claim 2, wherein
each of the MIM type electron sources has capacitance, and
capacitance of electron sources for causing each phosphor to emit light is reduced by connecting the MIM type electron sources in series.

4. The image display apparatus according to claim 2, wherein the two electron sources connected in series are subject to the same drive.

5. The image display apparatus according to claim 2, wherein the two electron sources connected in series are subject to different drives.

6. The image display apparatus according to claim 2, wherein as to at least two electron sources associated with each of the red, blue and green phosphors, two electron sources associated with each of two phosphors are subject to different drives.

7. The image display apparatus according to claim 6, wherein
the two phosphors are red and blue phosphors, and
as to two electron sources associated with each of the red and blue phosphors, voltage-electron emission characteristics of one of the two electron sources are lower than voltage-electron emission characteristics of the other of the two electron sources.

8. An image display apparatus comprising:
a cathode substrate having m row wires and n column wires formed thereon, and having (m×n) electron sources at intersections of the row wires and the column wires arranged in a matrix form;
an anode substrate having phosphors of three colors, i.e., blue, green and red colors formed thereon so as to be opposed to the electron sources;
data drive circuits for applying drive signals based on a video signal to the n column wires; and
scan drive circuits for applying a selection signal for selecting at least one row, successively to the m row wires in a column direction,
wherein
the electron sources are capacitive electron sources formed by sandwiching an insulation layer between two metal layers, and
at least two electron sources are connected in series so as to be associated with each of the blue, green and red phosphors.

9. The image display apparatus according to claim 8, wherein the electron sources are MIM (Metal Insulator Metal) type elements.

10. The image display apparatus according to claim 8, wherein as to at least two electron sources associated with each of the red, blue and green phosphors, two electron sources associated with each of two phosphors are subject to different drives.

11. The image display apparatus according to claim 8, wherein
the two phosphors are red and blue phosphors, and
as to two electron sources associated with each of the red and blue phosphors, voltage-electron emission characteristics of one of the two electron sources are lower than voltage-electron emission characteristics of the other of the two electron sources.
